(19) United States
(12) Patent Application Publication
(10) Pub. No.: US 2026/0161694 A1
(43) Pub. Date: Jun. 11, 2026

(54) Automated Tool For Determining And Using Dwelling Attribute Utility Data For Dwelling Similarity Rankings

(71) Applicant: MFTB Holdco, Inc., Seattle, WA (US)

(72) Inventors: Andy Lee Krause, Seattle, WA (US); Angela Burden, Asheville, NC (US); Faraz Moghimi, Quincy, MA (US)

(21) Appl. No.: 18/972,562

(22) Filed: Dec. 6, 2024

(51) Int. Cl. G06F 16/338; G06F 16/335; G06F 16/35; G06Q 50/16

(52) U.S. Cl. CPC G06F 16/338; G06F 16/335; G06F 16/35; G06Q 50/16

(57) ABSTRACT

Techniques are described for performing automated operations involving automatically quantifying differences between pairs of dwellings based on differences between the dwellings'dwelling attributes and the assessed contributions of such differing dwelling attributes to differences in overall dwelling utility of the two dwellings of a pair, and using determined difference quantifications between various dwellings for providing search results or other automated functionality based on dwelling similarity. In at least some situations, a difference quantification between a candidate dwelling and a target dwelling is determined based on a cumulative total of the absolute values of positive and negative utility scores associated with the differing dwelling attributes'values for the target dwelling and that candidate dwelling, such as by using a predictive model (e.g., a neural network model) trained to predict an overall utility score for a dwelling based on a plurality of dwelling attributes and associated values for that dwelling.

### TECHNICAL FIELD

The following disclosure relates generally to techniques for automatically quantifying and using overall differences between pairs of dwellings based on differences between the dwelling attributes of two dwellings of a pair and the assessed contributions of such differing dwelling attributes to differences in overall dwelling utility of the two dwellings, such as for use in providing search results based on similarity to an indicated dwelling.

### BACKGROUND

An abundance of information is available to users on a wide variety of topics from a variety of sources. For example, portions of the World Wide Web (“the Web”) are akin to an electronic library of documents and other data resources distributed over the Internet, with billions of documents available, including groups of documents directed to various specific topic areas (e.g., buildings of various types). In addition, various other information is available via other communication mediums. However, existing search engines and other techniques for identifying information of interest suffer from various problems. Non-exclusive examples include a difficulty in understanding natural language requests, difficulty in providing accurate information that is specific to a particular topic of interest and/or useful to a particular user, difficulty in limiting information requests to approved topics, etc.

### BRIEF DESCRIPTION OF THE DRAWINGS

FIGS. 1A-1B are network diagrams illustrating an example system for performing described techniques, including automatically quantifying and using overall differences between dwellings based on assessed contributions of differing dwelling attributes between the dwellings to differences in overall dwelling utility of the dwellings.

FIGS. 2A-2D illustrate examples of performing described techniques, including automatically quantifying and using overall differences between dwellings based on assessed contributions of differing dwelling attributes between the dwellings to differences in overall dwelling utility of the dwellings.

FIG. 3 is a block diagram illustrating an example of a computing system for use in performing described techniques, including automatically quantifying and using overall differences between dwellings based on assessed contributions of differing dwelling attributes between the dwellings to differences in overall dwelling utility of the dwellings.

FIGS. 4A-4B illustrate a flow diagram of an example embodiment of an Automated Dwelling Attribute Utility Assessor (“ADAUA”) system routine.

FIG. 5 illustrates a flow diagram of an example embodiment of an ADAUA Candidate Dwelling Similarity Determiner component routine.

FIG. 6 illustrates a flow diagram of an example embodiment of a client device routine.

### DETAILED DESCRIPTION

The present disclosure describes techniques for using computing devices to perform automated operations involving automatically quantifying overall differences between pairs of dwellings based on differences between the dwelling attributes of two dwellings of a pair and the assessed contributions of such differing dwelling attributes to differences in overall dwelling utility of the two dwellings, and using determined overall difference quantifications between various dwellings for providing search results or other automated functionality based on dwelling similarity (e.g., with the inter-dwelling similarity between two dwellings increasing as the difference quantification between the two dwellings decreases). In at least some embodiments, the automated operations include determining and ranking similarity of multiple candidate dwellings to another target dwelling based on utility scores associated with differing dwelling attribute values between the target dwelling and the multiple candidate dwellings, such as to determine an overall difference quantification between a candidate dwelling and a target dwelling that is based on a cumulative total of the absolute values of positive and negative utility scores associated with the differing dwelling attributes'values for the target dwelling and that candidate dwelling. The determining of the utility scores associated with differing dwelling attribute values for the target dwelling and the multiple candidate dwellings may be performed in various manners in various embodiments, including in some embodiments by using a predictive model (e.g., a predictive neural network model) trained to predict an overall utility score for a dwelling based on a plurality of dwelling attributes and associated values for that dwelling, as discussed in greater detail below. In addition, the multiple ranked candidate dwellings for a target dwelling may be used in various manners in various embodiments, including to provide search results of dwellings that are similar to the target dwelling (e.g., that are ranked by degree of similarity using determined difference quantifications) or in other manners, as is also discussed in greater detail below. Additional details are included below regarding automatically quantifying differences between pairs of dwellings based on differences between the dwelling attributes of two dwellings of a pair and the assessed contributions of such differing dwelling attributes to differences in overall dwelling utility of the two dwellings, and some or all of the techniques described herein may, in at least some embodiments, be performed via automated operations of an Automated Dwelling Attribute Utility Assessor (“ADAUA”) system, as discussed further below.

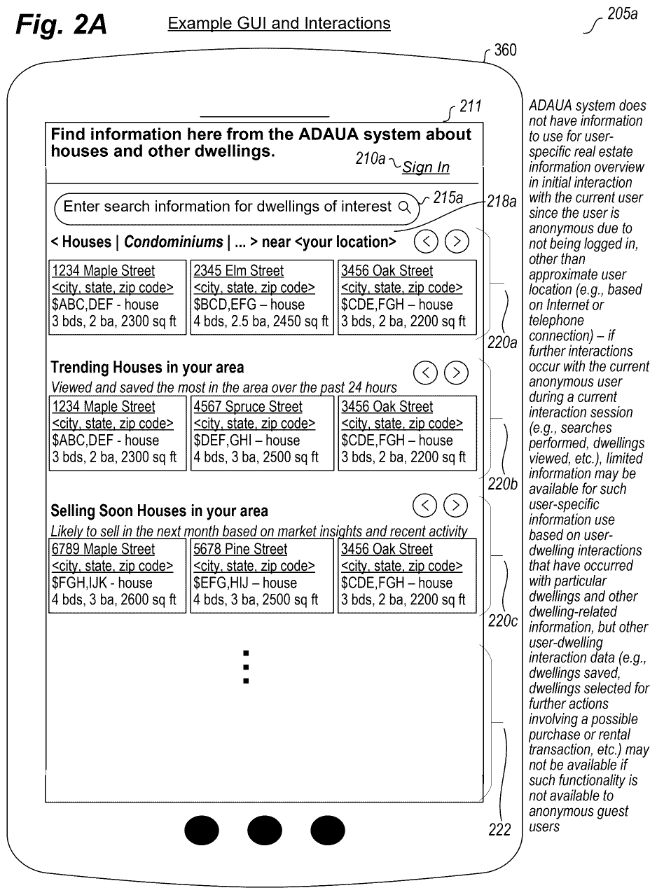

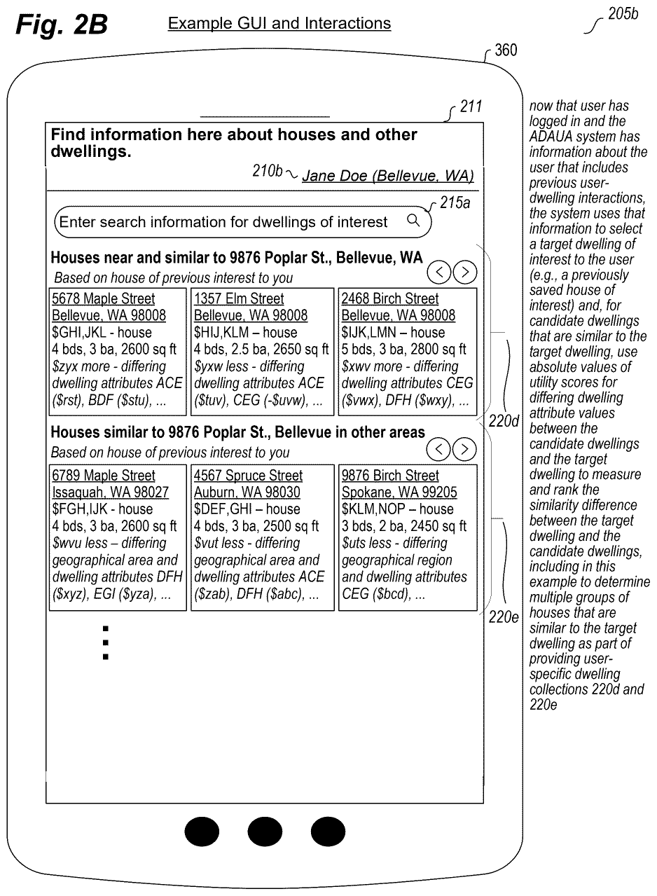

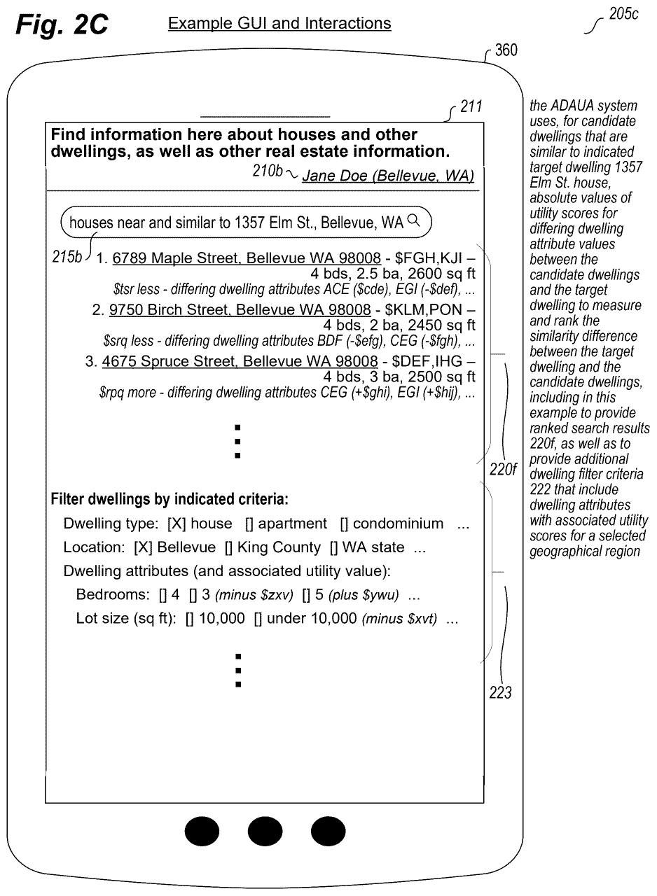

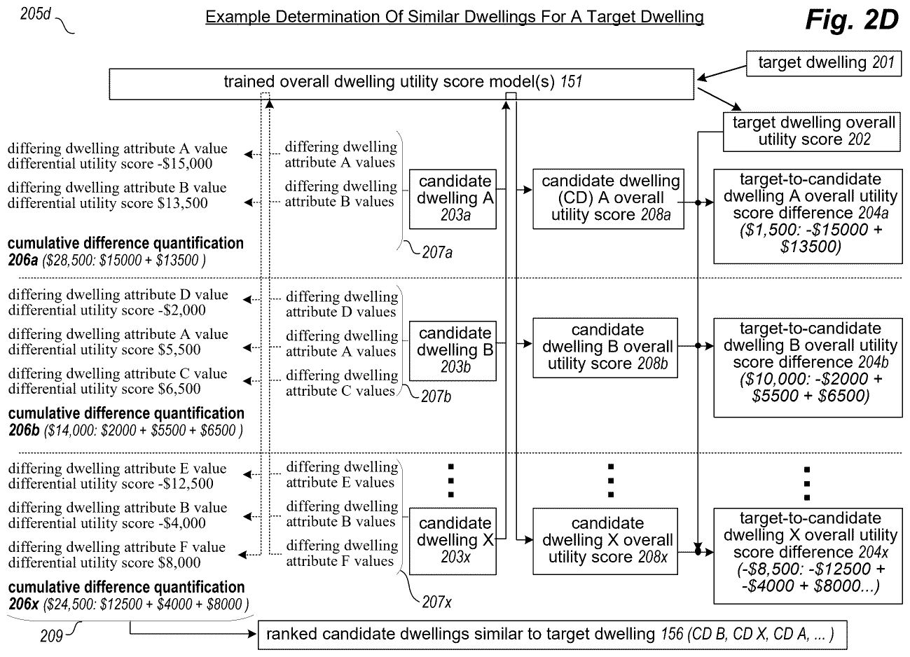

As noted above, the automated operations of the ADAUA system in at least some embodiments include determining and ranking similarity of multiple candidate dwellings to another target dwelling. The target dwelling may be determined in various manners in various embodiments, such as to be indicated as part of a search request from a user, to be determined from previous interactions of a user with the target dwelling (e.g., to save the target dwelling for later review), to be performed for each of some or all dwellings in a geographical area, etc., including in some embodiments and situations to be a current dwelling of a user—such previous interactions of users with dwellings may include, for example, viewing online information about the dwellings, saving or adding the dwellings to an online list or group for later review, selecting the dwellings for further interaction (e.g., visiting in person), etc. Similarly, the candidate dwellings for a target dwelling may be determined in various manners, such as to include some or all dwellings in one or more geographical areas (e.g., one or more neighborhoods, cities, zip codes, census-designated places, etc.), such as the same geographical area of the target dwelling or within a defined distance of the target dwelling or other indicated location, or instead for one or more larger geographical regions (e.g., one or more cities, counties, multi-city metropolitan areas or metropolitan statistical areas, states, countries, etc.) containing the target dwelling or as otherwise indicated, and optionally limited to dwellings that are available for acquisition and/or occupancy and/or to dwellings of one or more indicated dwelling types (e.g., houses, homes, apartments, condominiums, short-term rentals, other buildings, etc., such as a same dwelling type as the target dwelling or otherwise one or more indicated dwelling types) and/or based on one or more other indicated criteria (e.g., based on received search criteria). The target and candidates dwellings may have a variety of dwellings attributes (e.g., keyword-value pairs, an indication of a binary presence or absence of an attribute, etc.), such as any quantifiable information about the dwellings (e.g., geographical location, quantity of bedrooms, quantity of bathrooms, square footage of the dwelling, square footage of the property on which the dwelling is located, quantity of garage spaces, quantity of parking spaces, school district, HOA fees, listing price, purchase price, price per dwelling square foot, pool or not, water view or not, etc.), including information that is included in an MLS (multiple listing service) listing, as well as additional information that is derivable from other quantifiable information (e.g., distance to one or more specified types of services or amenities, such as a hospital, grocery store, park, etc. ; estimated total monthly payments to finance a purchase with a specified down payment, such as to include a mortgage for the listing or purchase price along with estimates of other fees such as taxes, insurance, HOA fees, etc. ; estimated total monthly payments to rent, such as to include estimates of other fees such as utilities and insurance; etc.)—for dwelling attributes that are not separated into keyword-value pairs (e.g., if the dwelling attribute is listed it represents the binary inclusion of that attribute), the dwelling attribute itself is treated herein as that dwelling attribute's value. In some embodiments and situations, the candidate dwellings for a target dwelling may be further selected to have a minimum level of similarity to the target dwelling based on having dwelling attribute values for a few designated dwelling attributes that are the same as the target dwelling's values for those designated dwelling attributes or that differ from the target dwelling's values for those designated dwelling attributes by at most a defined maximum (e.g., within 1 for enumerated quantities; within a defined percentage difference, such as 5% or 10%; etc.), such as for quantity of bedrooms, quantity of bathrooms, square footage of the dwelling, square footage of the dwelling's property, listing price, purchase price, etc. Additional details are included below related to target and candidate dwellings and their dwelling attributes, including with respect to the non-exclusive examples of FIGS. 2A-2D.

In at least some embodiments and situations, the quantifying of the overall differences between two dwellings such as a target dwelling and a candidate dwelling is performed to reflect a difference in predicted overall utility scores for those two dwellings. For example, one or more neural network models or other predictive models may be trained to predict overall utility scores for a dwelling based on a combination of some or all of its dwelling attributes and their associated values (e.g., 50 dwelling attributes, 100 dwelling attributes, etc.), and may be used to predict an overall utility score for each of the two dwellings being compared (e.g., a predicted price of the value of the dwelling or other representation of the utility of the dwelling), with the difference in the overall utility scores for the two dwellings indicating one type of comparison of the two dwellings. The described techniques proceed to further quantify the overall differences between the two dwellings based at least in part on the particular differing dwelling attributes whose values differ between the two dwellings. In particular, in at least some embodiments and situations, the one or more trained predictive models may be used to, for each differing dwelling attribute between the two dwellings, determine a differential utility score for that differing dwelling attribute to assess the contribution of that differing dwelling attribute to the overall utility score differences between the two dwellings, and to further use the determined differential utility scores of the various differing dwelling attributes to quantify the overall differences between the two dwellings—in at least some such embodiments and situations, the determined differential utility scores of the various differing dwelling attributes may include both positive and negative assessed contributions (e.g., a larger relative quantity of bedrooms or bathrooms or square footage with respect to another dwelling may provide an assessed positive differential utility score that positively contributes to a dwelling's overall utility score difference with the other dwelling, while a smaller relative quantity of bedrooms or bathrooms or square footage with respect to another dwelling may provide an assessed negative differential utility score that negatively contributes to the dwelling's overall utility score difference with the other dwelling) and may in the aggregate combine to be the overall utility score difference between the two dwellings, while the quantification of the overall differences between the two dwellings may combine the determined differential utility scores of the various differing dwelling attributes in other manners (e.g., by combining the absolute values of the determined differential utility scores, by using weighting or otherwise altering the effect of determined differential utility scores for particular differing dwelling attributes, etc.). As a simple example, consider a target dwelling and a candidate dwelling that differ only by two dwelling attributes, with the target dwelling having one more bedroom than the candidate dwelling, and the candidate dwelling having one more bathroom than the target dwelling—if the difference in overall utility scores between the two dwellings is $10K higher for the candidate dwelling than the target dwelling, that could be based on the candidate dwelling's bathroom quantity differing dwelling attribute having an assessed differential utility score of +$100K and the candidate dwelling's bathroom quantity differing dwelling attribute having an assessed differential utility score of −$90K, while the quantified overall difference between the two dwellings based on those two differing dwelling attributes may be $190K if absolute values of the two differing dwelling attributes'differential utility scores are combined.

The determination of the differential utility score of a differing dwelling attribute between two dwellings to assess its contribution to the overall utility score differences between the two dwellings may be performed in various manners in various embodiments. For example if a trained predictive neural network model (e.g., a fully connected feed forward neural network) or other trained predictive model is available to predict overall utility scores for a given dwelling, the differential utility score of a differing dwelling attribute between the two dwellings (e.g., the contribution of a differing value for that differing dwelling attribute, the contribution of the differing dwelling attribute being present for one dwelling and absent for the other dwelling, etc.) may be assessed in one or more of the following non-exclusive manners: by using internal weighting data from within a trained predictive neural network model or other internal data from within another type of trained predictive model, such as to compare the activation of each node to a reference activation or other baseline and assign corresponding contribution scores to the difference, or to other otherwise use gradients from the neural network to assess the contributions (e.g., with the baseline being based on another dwelling to which a current dwelling is being compared); by using Shapley values to distribute gains or costs among multiple differing dwelling attributes to reflect their contributions to a difference in overall utility scores based on average marginal contributions of each differing dwelling attribute across all possible coalitions; by using feature permutation to input different possible values of each differing dwelling attribute to the trained predictive model while holding other inputs constant in order to assess corresponding changes in model output; by using conditional expectations approaches to assess regression of the trained predictive neural network model (e.g., to assess effects of differing values of differing dwelling attributes), such as by determining expected values of random variables with respect to conditional probability distributions; etc. Alternatively, if such a trained predictive model is not available, the determination of the differential utility score of a differing dwelling attribute between two dwellings to assess its contribution to the overall utility score differences between the two dwellings may be performed in other manners, such as to generate a linear model to represent associations of the differing dwelling attributes to a dwelling's overall utility score (e.g., as provided via manual input of an operator user of the ADAUA system) or to represent associations of the differing dwelling attributes to an overall utility score difference between the two dwellings (e.g., as provided via manual input of an operator user of the ADAUA system), and to use normalized coefficients of the linear model to assess the differing dwelling attributes'contributions. Additional details are included below related to the quantifying of the overall differences between two dwellings, including with respect to the non-exclusive examples of FIGS. 2A-2D.

As noted above, the automated operations of the ADAUA system in at least some embodiments include using the quantified overall differences between pairs of dwellings (e.g., between a target dwelling and each of multiple candidate dwellings) in various manners, such as for providing search results or other automated functionality based on dwelling similarity. As one nonexclusive example, a search request may be received from a user that indicates a target dwelling or a target dwelling associated with that user may be otherwise determine, and the generation of the corresponding search results may include determining multiple candidate dwellings for comparison to the target dwelling and determining quantified overall differences between that target dwelling and each of the candidate dwellings, ranking similarity of the candidate dwellings to the target dwelling based at least in part on their associated quantified overall differences (and optionally in combination with one or more other indicated criteria, such as other search criteria provided as part of the search request), and providing some or all of the candidate dwellings as part of the corresponding search results (e.g., to select a subset of the candidate dwellings based on the rankings of their associated quantified overall differences, such as a fixed quantity or percentage of the candidate dwellings; to order some or all of the candidate dwellings based on the rankings of their associated quantified overall differences; etc.). As another nonexclusive example, one or more target dwellings may be indicated by or otherwise associated with a user, and quantified overall differences of multiple candidate dwellings to at least one of the one or more target dwellings may be used to select a collection or other group of candidate dwellings to provide together to the user, such as part of a larger group of information (e.g., a home page or other group of overview information related to dwellings). As yet another nonexclusive example, one or more target dwellings may be indicated by or otherwise associated with a user, and quantified overall differences of multiple candidate dwellings to at least one of the one or more target dwellings may be used to generate and provide filter criteria for selection by the user, such as to determine average or other composite differential utility scores associated with each of one or more values of each of some or all differing dwelling attributes between the at least one target dwelling and multiple determined candidate dwellings, and to provide those determined differential utility scores for those differing dwelling attribute values along with functionality for the user to optionally select one or more such differing dwelling attribute values to use in identifying dwellings that match the user-selected filter criteria. Such composite differential utility scores associated with each of one or more values of each of some or all differing dwelling attributes for a target dwelling may be further used in other manners in other embodiments, including to provide information about overall utility score changes for the target dwelling if it is remodeled or otherwise modified. In some embodiments and situations, candidate dwellings from multiple different geographical regions may be selected and separately assessed, such as to provide comparative information about composite differential utility scores associated with particular dwelling attribute values (e.g., for use in comparing utility scores associated with a target dwelling or otherwise with a group of specified dwelling attribute values in different geographical regions). It will be appreciated that determined differential utility scores for different dwelling attributes and quantified overall differences between two dwellings may be used in other manners in other embodiments, and additional details are included below related to the use of quantified overall differences between two dwellings and/or associated determined differential utility scores associated with differing dwelling attributes between the two dwellings, including with respect to the non-exclusive examples of FIGS. 2A-2D.

The described automated techniques provide various benefits in various embodiments, including to significantly improve the identification and use of responsive information to specified queries for information about dwellings based at least in part on quantified overall differences between two dwellings and/or associated determined differential utility scores associated with differing dwelling attributes between the two dwellings. Such automated techniques also allow such responsive answer information to be generated more efficiently than previously existing techniques (e.g., using less storage and/or memory and/or computing cycles) and with greater accuracy, based at least in part on using the described techniques for improving the accuracy and relevance of information provided to users in user-specific manners, etc. In addition, in some embodiments the described techniques may be used to provide an improved GUI (graphical user interface) in which a user may more accurately and quickly obtain real estate-related information, including in response to an explicit request (e.g., in the form of a natural language query), as part of providing personalized information to the user, etc. Various other benefits are also provided by the described techniques, some of which are further described elsewhere herein.

In at least some embodiments, the automated operations of the ADAUA system may further include, before using a trained predictive neural network model or other trained predictive model to predict overall utility scores for dwellings based on their dwelling attributes, generate or otherwise train one or more such predictive models (e.g., one for each of multiple different geographical regions, one overall predictive model for all geographical regions of interest, etc.). In at least some embodiments, the techniques may include determining information about a plurality of dwellings that includes some or all dwelling attributes of those dwellings (e.g., a subset of the dwelling attributes selected to use as input to the predictive model(s)) and associated overall utility scores for the dwellings (e.g., recent sales prices for dwellings if the current monetary house value is the utility score basis; manually supplied overall utility scores, such as values from assessors; etc.), and providing that information as training data to the predictive model. Other model types may be used in other embodiments, whether in addition to or instead of neural network models (e.g., linear models) and may be trained in a similar manner or as otherwise described herein, etc. In other embodiments, multiple predictive models may be generated and used in other manners, such as to segment each such predictive model by one or more user characteristics (e.g., gender, age, etc.) as permitted by applicable laws and regulations, such as to reflect individual utility values specific to users having the user characteristic(s).

In addition, in at least some embodiments, some or all user queries may be entered using multiple free-form natural language terms to specify one or more search criteria, and if so the ADAUA system may analyze such a query to determine the user-specified criteria to use, including by segmenting the terms in the received query into one or more segments each corresponding to an indicated search criterion. Such segmenting of the sequence of term(s) may be performed in various manners in various embodiments, such as by using specified criteria to determine if one or more target dwellings have been specified in the terms (e.g., by address; by a unique identifier, such as an MLS number; etc.), etc. Additional details are included herein related to analyzing a sequence of one or more terms of a received query that is specified using free-form natural language.

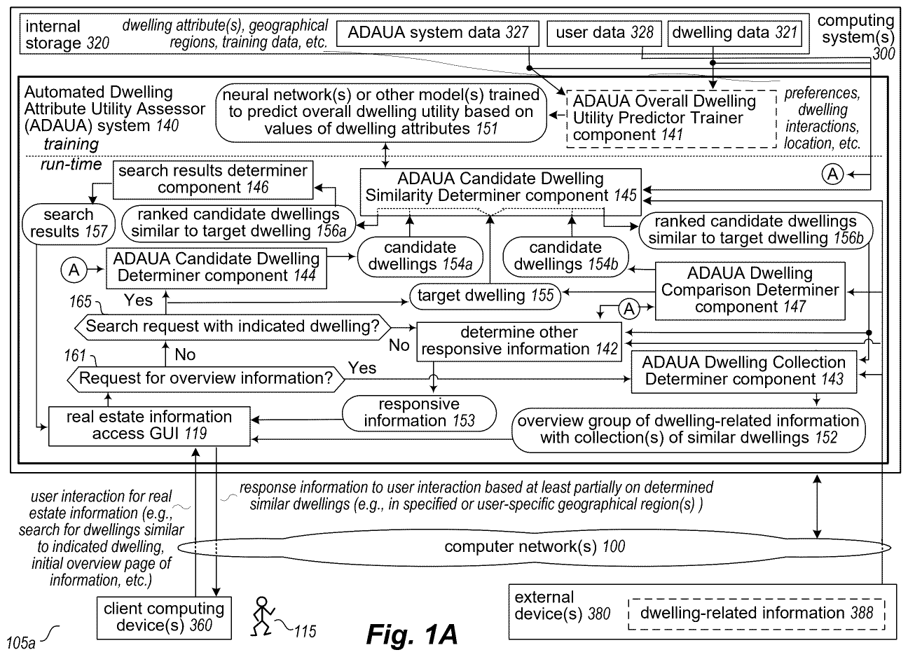

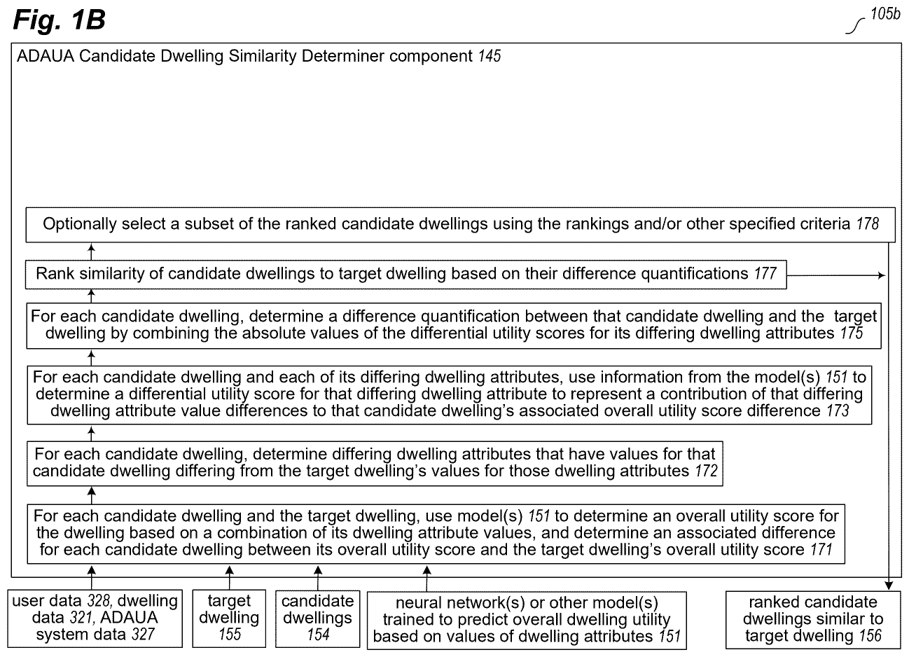

FIGS. 1A-1B are network diagrams illustrating an example system for performing described techniques, including automatically quantifying and using overall differences between two dwellings based on assessed contributions of differing dwelling attributes between the two dwellings to differences in overall dwelling utility of the two dwellings.

In particular, FIG. 1A illustrates information 105a about an example embodiment of an ADAUA system 140 executing on one or more computing systems 300, and interacting over one or more computer networks 100 with one or more client computing devices 360, such as to receive query requests from users 115 of the client computing devices for information about dwellings and to provide corresponding responses (e.g., as part of search results). In the illustrated embodiment, the computing system(s) 300 may store various information on storage 320 that is used by the ADAUA system during operation, including dwelling data 321 about dwellings in one or more geographical areas, user data 328 (e.g., user location; prior user interaction data for interactions of one or more types with dwellings, such as via the ADAUA system, and optionally additional received interaction data for further interactions of the user outside the ADAUA system with one or more dwellings, including in-person interactions; user preferences, such as expressly specified and/or implicitly determined from past activities of the user such as viewing or otherwise interacting with information about dwellings; etc.), and ADAUA system data 327 (e.g., stored in one or more databases, such as about one or more of the following: geographical regions; some or all dwelling attributes and optionally possible values for each such dwelling attribute, such as dwelling attributes used to determine a dwelling's overall utility score and/or that are compared between two dwellings in order to identify differing dwelling attributes; optionally training data for use in training one or more predictive models; names and locations of POI locations and associated POI categories; information for use in natural language segment determination, such as word-break and/or phrase-break vocabularies; etc.). The ADAUA system may further optionally retrieve and use other dwelling-related information 388 of one or more types stored externally to the computing systems 300, such as accessed over the one or more computer networks 100 from one or more external computing and/or storage devices 380, whether in addition to or instead of information stored on storage 320, and optionally including information about user interactions outside of the ADAUA system with dwellings.

As one example of operations of the ADAUA system 140, an optional ADAUA Overall Dwelling Utility Predictor Trainer component 141 performs activities to generate and train one or more predictive neural network models or other types of predictive models 151 for use in predicting overall utility scores for dwellings based on a combination of dwelling attributes of the dwellings, including to obtain, as input, dwelling data 321 about dwellings (including attributes of the dwellings) and one or more types of ADAUA system data 327 (e.g., training data, such as information about a plurality of dwellings that includes some or all dwelling attributes of those dwellings and associated overall utility scores for the dwellings, and optionally about regions for which to generate and train region-specific predictive models, etc.), and optionally user data 328 (including information about one or more user characteristics for which to generate and train user-specific predictive models, such as to reflect one or more of user preferences, prior user dwelling interactions, user location, etc.). In other embodiments and situations, the ADAUA system may instead obtain and use one or more previously trained predictive models (whether previously trained by the ADAUA system or other system), or generate and use one or more other types of models (e.g., linear models). Additional details are included elsewhere herein related to the generation and training of the one or more predictive models 151.

After the one or more predictive models 151 have been generated, the example operations may further include an ADAUA Dwelling Comparison Determiner component 147 that receives dwelling data 321 and ADAUA system data 327 and optionally user data 328, selects one or more of the dwellings to use as target dwellings 155 for which to determine similar dwellings based on quantified differences with the target dwelling(s) (e.g., some or all dwellings in one or more geographical regions, one or more target dwellings associated with each of one or more users of the ADAUA system, one or more target dwellings indicated by another ADAUA system, etc.), and determines candidate dwellings 154b for each of the target dwellings (e.g., via a request to the ADAUA Candidate Dwelling Determiner component 144, as discussed further below). The operations then include supplying each target dwelling and its associated candidate dwellings to the ADAUA Candidate Dwelling Similarity Determiner component 145, which uses the one or more predictive models 151 to generate a ranking 156b of the candidate dwellings based on similarity to the target dwelling using determined quantified difference measures for the candidate dwellings based on differing dwelling attributes between the target dwelling and the candidate dwellings, and with additional details included in FIG. 1B. The ranked candidate dwellings 156b may further be used as part of responsive information 142 and/or overview dwelling information 152, as discussed further below.

The example operations may further include a particular user 115 of one of the client computing devices 360 supplying a query for dwelling-related information (e.g., about one or more criteria in a natural language free-form input for use in identifying particular dwellings of interest) to GUI 119 provided by the ADAUA system. The GUI proceeds to block 161 to determine if the received query is a request for overview information, and if so continues to block 143 to perform an ADAUA Dwelling Collection Determiner component 143 to retrieve an overview group of dwelling-related information and to optionally further determine one or more collections or other groups of dwellings similar to an identified target dwelling (e.g., a target dwelling associated with the user, if known, who submitted the query for dwelling-related information) to combine with the overview group of dwelling-related information, with the output 152 from the component 143 provided to the GUI 119 for use in a response to the received query. In particular, if an identified target dwelling is available, the component 143 may use ranked candidate dwellings 156b similar to that target dwelling to determine the one or more collections or other groups of dwellings similar to the target dwelling, such as if ranked candidate dwellings 156b were previously determined for the target dwellings, or instead by supplying an indication of the target dwelling to the component 147 to cause corresponding ranked candidate dwellings 156b to be generated.

If it is instead determined in block 161 that the received query is not a request for overview information, the routine continues instead to block 165 to determine if the received query is a search request from the user that indicates a target dwelling for which to identify similar dwellings (optionally along with one or more indicated criteria), and if so continues to block 144 to perform the ADAUA Candidate Dwelling Determiner component to determine candidate dwellings 154a for comparison to the indicated target dwelling 155, such as is discussed in greater detail elsewhere herein. The operations then include supplying the target dwelling and its associated candidate dwellings 154a to the ADAUA Candidate Dwelling Similarity Determiner component 145, which uses the one or more predictive models 151 to generate a ranking 156a of the candidate dwellings based on similarity to the target dwelling using determined quantified difference measures based on differing dwelling attributes between the target dwelling and the candidate dwellings. The ranked candidate dwellings 156a are then further supplied to the search results determiner component 146, which generates search results 157 by selecting a subset of the ranked candidate dwellings 156a (e.g., based on the rankings and/or other specified search criteria) and/or orders some or all of the ranked candidate dwellings 156a based on the rankings, with the search results 157 provided to the GUI 119 for use in a response to the received query.

If it is instead determined in block 165 that the query is not a search query with an indicated dwelling to use as a target dwelling, the routine continues instead to block 142 to determine other responsive information to the received query, optionally including information from ranked candidate dwellings 156b, with the resulting responsive information 153 then provided to the GUI 119 for use in response to the query.

The same user may then provide one or more subsequent queries to the GUI 119 as part of an ongoing search interaction session, such as with similar processing performed for the subsequent user queries, and optionally with the context of prior interactions during the session being maintained and used by the ADAUA system. In addition, a user may in some embodiments and situations provide optional user feedback, such as to provide feedback regarding accuracy of a search results response or to provide further clarifying information in response to a corresponding request, to specify further user preferences to be used, etc. If so, such optional user feedback may be forwarded to the components 141 and/or 143 and/or 144 and/or 145 and/or 147, such as to improve future determinations performed by the components. In other embodiments and situations, some or all such feedback may instead be implicit feedback that is determined based on an analysis of subsequent user queries (e.g., to indicate that a prior query response did not provide information that the user was seeking) and/or of prior user queries (e.g., to determine user preferences and/or user location, such as based on patterns in the prior user queries). While the example discussed above involves a single user performing multiple interactions with the ADAUA system as part of an interaction session (e.g., spanning seconds, minutes, hours, days, etc.), it will be appreciated that the ADAUA system may in at least some embodiments and situations be concurrently interacting with many users using different client computing devices, such as to maintain a separate GUI and interaction session history for each such user, and that a new interaction session may be initiated for a user after one or more prior interaction sessions with that user in various manners (e.g., based on a corresponding user instruction, such as to reflect a change in the types of dwelling information of interest; as determined automatically by the ADAUA system, such as to reflect a change in the types of dwelling information being requested, or due to a defined period of time since a last user interaction being exceeded, such as one or more days; etc.).

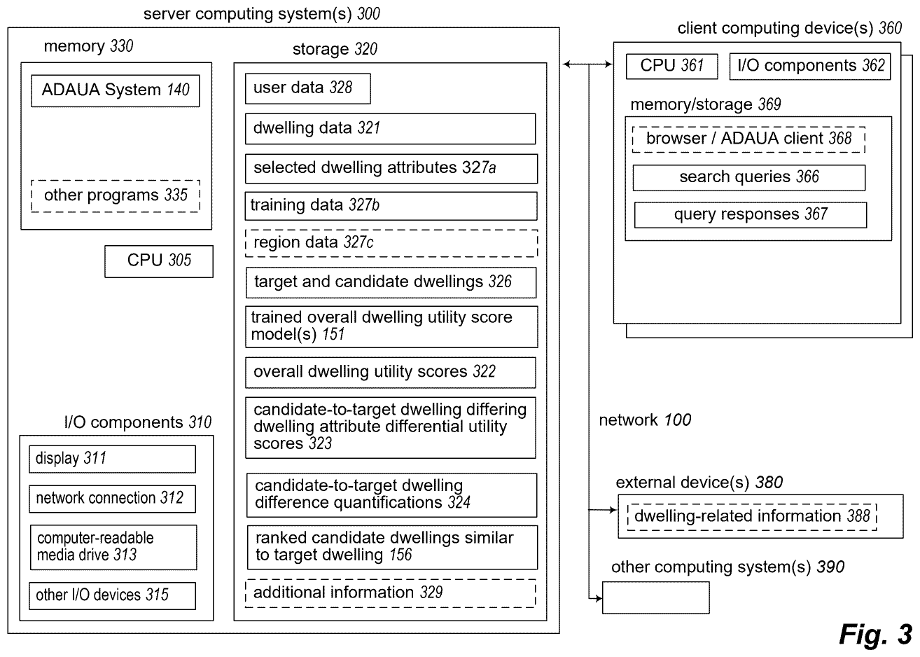

In addition, the computing system(s) 300 may include various other components and functionality, as discussed in greater detail elsewhere herein, including with respect to FIG. 3. The computer networks 100 may similarly be of various types in various embodiments and may include various types of wired and/or wireless segments, including one or more publicly accessible linked networks (e.g., operated by various distinct parties, such as the Internet) and/or a private network (e.g., a corporate or university network that is wholly or partially inaccessible to non-privileged users), including in some cases to have both private and public networks (e.g., with one or more of the private networks having access to and/or from one or more of the public networks).

FIG. 1B continues the example of FIG. 1A, and illustrates information 105b for one example embodiment of the ADAUA Candidate Dwelling Similarity Determiner component 145 discussed in FIG. 1A. In particular, in the illustrated embodiment, the component 145 performs various activities to use one or more predictive models to generate a ranking of candidate dwellings based on similarity to a target dwelling using determined quantified difference measures for the candidate dwellings based on differing dwelling attributes between the target dwelling and the candidate dwellings.

In operation, the component 145 receives, as input, dwelling data 321 about various dwellings in one or more geographical regions (including attributes of the dwellings), ADAUA system data 327 (e.g., information about geographical regions; some or all dwelling attributes and optionally possible values for each such dwelling attribute, such as dwelling attributes used to determine a dwelling's overall utility score and/or that are compared between two dwellings in order to identify differing dwelling attributes; etc.), an indication of a target dwelling 155, information about candidate dwellings 154 associated with the target dwelling, an indication of one or more predictive models 151 trained to predict overall utility scores for dwellings based on the dwelling attributes of the dwellings, and optionally user data 328 (e.g., user location, user preferences, etc.). In particular, in block 171 the component determines, for each candidate dwelling and the target dwelling and by using the one or more models 151, an overall utility score for the dwelling based on a combination of its dwelling attributes, and further determines an associated difference for each candidate dwelling between its overall utility score and the overall utility score of the target dwelling. In block 172, the component then, for each candidate dwelling, determines differing dwelling attributes relative to the target dwelling that have values for that candidate dwelling that differ from the target dwelling's values for those dwelling attributes. In block 173, the component then, for each candidate dwelling and each of its differing dwelling attributes, uses information from the one or more models 151 to determine a differential utility score for that differing dwelling attribute to represent a contribution to that candidate dwelling's associated overall utility score difference with the target dwelling from that differing dwelling attribute based on the differences in its value for the candidate dwelling relative to the target dwelling. In block 175, the component then, for each candidate dwelling, determines an overall difference quantification between that candidate dwelling and the target dwelling by combining the absolute values of the differential utility scores for the differing dwelling attributes of that candidate dwelling, and in block 177 ranks the similarity of the candidate dwellings to the target dwelling based on their difference qualifications. After block 177, the component optionally performs block 178 to select a subset of the ranked candidate dwellings using the rankings and/or one or more other specified criteria, and then proceeds from block 178 if performed or otherwise from block 177 to provide resulting ranked candidate dwellings 156 that are similar to the target dwelling.

It will be appreciated that various details are provided with respect to FIGS. 1A-1B for illustrative purposes, and are not intended to limit the scope of the invention unless otherwise indicated. Similarly, additional exemplary details are provided with respect to FIGS. 2A-2D and elsewhere herein, and such details are similarly provided for illustrative purposes and are not intended to limit the scope of the invention unless otherwise indicated.

FIGS. 2A-2D illustrate examples of performing described techniques, including automatically determining and using information about one or more user-specific predicted attributes of dwellings that users will occupy in the future.

In particular, FIG. 2A illustrates information 205a including an example client computing device 360 (in this example, a smartphone) that is being used by a user (not shown) to interact with a GUI provided by the ADAUA system, with current information 211 displayed in the GUI. In this example, the current information 211 corresponds to overview dwelling-related information provided in response to a previous request (e.g., a request to load a home page of a corresponding Web site), with the displayed information including a search box 215a, a user-selectable control 210a via which the user may sign in, and various groups of information 220 and 222 related to multiple types of dwelling-related information. In this example, the displayed information includes a first group of information 220a to show information about specific example houses near the user's location (e.g., based on an automatically determined location of the user or the user's client device) as indicated 218a, which in this example includes three example houses and user-selectable controls to view additional houses of that type-information about other types of dwellings (e.g., apartments, condominiums, etc.) may be provided, whether in addition to or instead of houses. The example provided information further includes a second group of information 220b about trending houses in a geographical area of the user (e.g., that were viewed and saved the most in the prior 24 hours), which again in this example includes three example houses and corresponding user-selectable controls to view additional houses of that type-in a similar manner to information 220a, information about other types of dwellings may be provided, whether in addition to or instead of houses. The example provided information also includes a third group of information 220c about houses expected to sell soon in a geographical area of the user, which in this example also includes three example houses and corresponding user-selectable controls to view additional houses of that type-in a similar manner to that of information 220a and 220b, information about other types of dwellings may be provided, whether in addition to or instead of houses. The example provided information may optionally further include additional information 222 related to real estate but not specific to particular types of houses, such as general information about selling or renting dwellings, about budget and financing, about finding a real estate agent, etc. In this example, since a target dwelling was not indicated by the user in their request and the ADAUA system does not have information about any target dwellings associated with the user (e.g., the user is not signed in and there are not sufficient prior interactions with the unknown user during a current interaction session to determine one or more target dwellings associated with the user), the initially provided information does not include information based on similarity of other candidate dwellings to any such target dwellings.

FIG. 2B continues the example of FIG. 2A, and illustrates information 205b showing updated overview dwelling-related information after the user has logged in 210b, which again includes the search box 215a, but in this example further includes additional dwelling-related information that is based on information specific to the user. In particular, in this example, the provided information includes a group of information 220d about candidate houses that are recommended for the user in a selected geographical area (e.g., a city in which that user has previously interacted with dwellings, a city in which the user is currently located or currently lives or has specified as a preference, etc.) based on the similarity of those candidate houses to a particular target dwelling associated with the user (e.g., previously saved by the user, which in this example is a house at ‘9876 Poplar St’ in Bellevue, WA)—in this example, the information 220d indicates three candidate houses that are near to and similar to a particular target dwelling of previous interest to the user (e.g., using similarities as determined by the ADAUA system based on quantified differences of various candidate dwellings with that target dwelling), and with user-selectable controls with which to view additional houses of that type. In addition, the provided information further includes additional details in this example about some or all differing dwelling attributes for each similar candidate house along with an estimated differential utility score associated with that differing dwelling attribute, such as to provide information to the user about why the candidate houses have different overall utility scores from that of the target dwelling, although in some embodiments such differing dwelling attributes and/or their associated differential utility scores may not be shown (whether as part of such summary information, or at all). The provided information 211 of FIG. 2B further includes one or more additional groups of information that are similarly based at least in part on one or more target dwellings for the user using prior interaction data for the user with other dwellings, including information 220e about candidate houses that are similar to the same target dwelling used for information 220d but that are in different geographical areas and/or regions, such as in this example to include two houses that are in different city geographical areas of the same overall geographical region and one additional house that is in a different geographical region in a different part of the same state. It will be appreciated that other types of overview dwelling-related information may be included in a manner similar to that discussed with respect to FIG. 2A, and/or that some of the illustrated types of information about candidate dwellings similar to one or more target dwellings may not be included. In addition, while the example provided information in FIGS. 2A-2B for the dwelling collections 220 are shown with information about specific dwellings, in other embodiments and situations the information for a collection may instead include a single user-selectable control that indicates the type of dwelling information but without showing information about specific dwellings, and with the information about the corresponding specific dwellings for the collection available to the user upon selection of the user-selectable control.

FIG. 2C continues the examples of FIGS. 2A-2B, and illustrates information 205c showing an additional example of using determined similarity of candidate dwellings to a target dwelling to provide information to a user, which in this example includes providing search results to the user in response to a received search query 215b. In particular, in this example, the user has entered a search query of “houses near and similar to 1357 Elm St., Bellevue, WA”, and the ADAUA system has determined a ranked list of candidate dwellings similar to that indicated target dwelling that are provided as part of search results 220f—in this example, three candidate dwellings are shown, and additional information about particular differing dwelling attributes and associated differential utility scores for each of the candidate dwellings are included, although such information may not be shown in other embodiments and situations. In addition, the example in FIG. 2C further illustrates using determined similarity information from the ADAUA system to provide filtering options 223 to the user, including in this example to show possible types of dwelling attributes along with possible values, and with the illustrated information in this example further showing determined utility score differences associated with different dwelling attribute values (e.g., for a current geographical area in which the candidate dwellings and target dwelling are located, such as to use an average differential utility score for a given dwelling attribute value across multiple candidate dwellings). Thus, for example, if the target dwelling includes four bedrooms, the filtering criteria may include an option to show candidate dwellings that include four bedrooms if the corresponding filter criteria checkbox is selected (not shown) and that would not have any associated difference in utility score, candidate dwellings that include three bedrooms if the corresponding filter criteria checkbox is selected (not shown) along with an indication that a change from four bedrooms to three bedrooms has an associated estimated negative differential utility score as shown, etc. In this example, the filtering criteria may also include additional dwelling attributes that are not based on similarity determinations from the ADAUA system, such as corresponding to dwelling type, geographical location, etc.

FIG. 2D continues the examples of FIGS. 2A-2C, and illustrates information 205d showing additional examples of operations of the ADAUA system in determining similarity of particular candidate dwellings to a target dwelling. In particular, in this example, a target dwelling 201 is provided and one or more trained overall dwelling utility score models 151 are used to generate a resulting predicted target dwelling overall utility score 202 for that target dwelling. In this example, the ADAUA system further determines various candidate dwellings A-X 203 to compare to the target dwelling, and similarly provides information about each candidate dwelling to the trained model(s) to generate a resulting candidate dwelling overall utility score 208, with a difference 204 between each candidate dwelling's overall utility score and that of the target dwelling further determined and illustrated. The ADAUA system further determines, for each of the candidate dwellings, one or more differing dwelling attributes 207 relative to the target dwelling, and uses information from the trained model(s) 151 to determine a corresponding differential utility score 206 for that differing dwelling attribute. As one non-exclusive example, the candidate dwelling A 203a is determined to have differing dwelling attributes 207a that include differing dwelling attributes A and B, with the differential utility score for differing dwelling attribute A determined to be a negative differential utility score (in this example −$15,000) and the differential utility score for differing dwelling attribute B determined to be a positive differential utility score (in this example $13,500), with the target-to-candidate dwelling A overall utility score difference 204a being a difference of −$1,500 based on those two differing dwelling attributes. However, the cumulative difference quantification 206a for candidate dwelling A is determined to be $28,500, as the absolute values of those differential utility scores are combined in this example to generate the difference quantifications for the candidate dwellings—thus, while candidate dwelling A has the same overall utility score difference in this example from the target dwelling, it has the largest difference quantification from the target dwelling in this example. Similar information is determined for each candidate dwelling, and the ADAUA system uses the determined difference quantifications 206 to generate a ranked group of candidate dwellings 156 based on similarity to the target dwelling, such as to have the candidate dwellings with the lowest difference quantifications 206 ranked highest (i.e., candidate dwelling B).

It will be appreciated that the examples of FIGS. 2A-2D are provided for illustrative reasons only, and are not intended to limit the scope of the invention. For example, a variety of other combinations of natural language free-form search terms may be used in other embodiments and situations.

In addition, further details related to at least some operations of the ADAUA system and its components are included in the following, each of which is herein incorporated by reference in its entirety: U.S. Non-Provisional Ser. No. 18/628,765, entitled “Automated Tool For Generating And Providing Housing-Related Information” and filed Apr. 7, 2024; U.S. Non-Provisional Ser. No. 18/583,602 , filed Feb. 21, 2024 and entitled “Automated Tool For Determining And Providing Building Information For Multiple Partially Described Proximate Geographical Regions”; in U.S. Non-Provisional Ser. No. 18/642,246 , filed Apr. 22, 2024 and entitled “Automated Tool For Determining And Using User-Specific Predicted Attributes Of Dwellings That Users Will Later Occupy”; in U.S. Non-Provisional Ser. No. 18/622,829 , filed Mar. 29, 2024 and entitled “Automated Tool For Determining And Providing Information About Dwellings Within Geographical Regions That Are Determined Specific To Indicated Locations”; in U.S. Non-Provisional Ser. No. 18/734,815, filed Jun. 5, 2024 and entitled “Automated Tool For Determining And Providing Information About Dwellings Satisfying Search Criteria Specified Using Multiple Data Modes”; in U.S. Non-Provisional Ser. No. 18/632,217 , filed Apr. 10, 2024 and entitled “Automated Tool For Determining And Providing Information About Dwellings Using Heterogenous Search Strategies”; in U.S. Non-Provisional Ser. No. 18/922,084 , filed Oct. 21, 2024 and entitled “Automated Tool For Using A Large Language Model To Select And Provide User-Specific Dwelling-Related Information Of Multiple Types”; and in U.S. Non-Provisional Ser. No. 18/818,039 , filed Aug. 28, 2024 and entitled “Automated Tool For Determining And Using User-Specific Dwelling Search Criteria To Provide Improved Search Results”.

For illustrative purposes, some embodiments are described herein in which specific types of information are acquired, used and/or presented in specific ways using specific types of data structures and by using specific types of devices however, it will be understood that the described techniques may be used in other manners in other embodiments, and that the invention is not limited to exemplary details provided. As one non-exclusive example, specific types of data structures and algorithms are generated and/or used in specific manners in some embodiments, but it will be appreciated that other types of information may be generated and used in other manners in other embodiments, including for types of information other than dwelling information. Similarly, while particular user interface display and interaction techniques are shown, other user interaction techniques may be used in other embodiments. In addition, various details are provided in the drawings and text for exemplary purposes, but are not intended to limit the scope of the invention-for example, sizes and relative positions of elements in the drawings are not necessarily drawn to scale, with some details omitted and/or provided with greater prominence (e.g., via size and positioning) to enhance legibility and/or clarity, and identical reference numbers may be used in the drawings to identify the same or similar elements or acts.

FIG. 3 is a block diagram illustrating an embodiment of one or more server computing systems 300 executing an implementation of an ADAUA system 140, such as in a manner similar to that of FIGS. 1A-1B and with additional hardware details illustrated-the server computing system(s) and ADAUA system may be implemented using a plurality of hardware components that form electronic circuits suitable for and configured to, when in combined operation, perform at least some of the techniques described herein. In the illustrated embodiment, each server computing system 300 includes one or more hardware central processing units (“CPU”) or other hardware processors 305, various input/output (“I/O”) components 310, storage 320, and memory 330, with the illustrated I/O components including a display 311, a network connection 312, a computer-readable media drive 313, and other I/O devices 315 (e.g., keyboards, mice or other pointing devices, microphones, speakers, GPS receivers, etc.).

The server computing system(s) 300 and executing ADAUA system 140 may communicate with other computing systems and devices via one or more networks 100 (e.g., the Internet, one or more cellular telephone networks, etc.), such as user client computing devices 360 (e.g., used to supply queries; receive responsive answers; and use the received answer information, such as to display or otherwise present answer information to users of the client computing devices and/or to implement further automated activities, such as to access other functionality provided by the ADAUA system), optionally other external devices 380 (e.g., used to store and provide dwelling information of one or more types), and optionally other computing systems 390.

In the illustrated embodiment, an embodiment of the ADAUA system 140 executes in memory 330 in order to perform at least some of the described techniques, such as by using the processor(s) 305 to execute software instructions of the system 140 in a manner that configures the processor(s) 305 and computing system 300 to perform automated operations that implement those described techniques. The illustrated embodiment of the ADAUA system may include one or more components, not shown, to each perform portions of the functionality of the ADAUA system, and the memory may further optionally execute one or more other programs 335. The ADAUA system 140 may further, during its operation, store and/or retrieve various types of data on storage 320 (e.g., in one or more databases or other data structures), such as various types of user data 328, dwelling data 321 (e.g., dwelling attributes and associated values, etc.), selected dwelling attribute data 327a, training data 327b, optionally region data 327c, one or more trained predictive models 151 (e.g., neural network models), target and candidate dwellings 326, overall dwelling utility scores 322, candidate-to-target dwelling differing dwelling attribute differential utility scores 323, candidate-to-target dwelling difference quantifications 324, ranked candidate dwellings 156 similar to a target dwelling, and/or various other types of optional additional information 329.

Some or all of the user client computing devices 360 (e.g., mobile devices), external devices 380, and other computing systems 390 may similarly include some or all of the same types of components illustrated for server computing system 300. As one non-limiting example, the computing devices 360 are each shown to include one or more hardware CPU(s) 361, I/O components 362, and memory and/or storage 369, with a browser and/or ADAUA client program 368 optionally executing in memory to interact with the ADAUA system 140 and to present or otherwise use query responses 367 that are received from the ADAUA system for submitted user queries 366. While particular components are not illustrated for the other devices/systems 380 and 390, it will be appreciated that they may include similar and/or additional components.

It will also be appreciated that computing system 300 and the other systems and devices included within FIG. 3 are merely illustrative and are not intended to limit the scope of the present invention. The systems and/or devices may instead each include multiple interacting computing systems or devices, and may be connected to other devices that are not specifically illustrated, including via Bluetooth communication or other direct communication, through one or more networks such as the Internet, via the Web, or via one or more private networks (e.g., mobile communication networks, etc.). More generally, a device or other computing system may comprise any combination of hardware that may interact and perform the described types of functionality, optionally when programmed or otherwise configured with stored contents that include particular software instructions and/or data structures, including without limitation desktop or other computers (e.g., tablets, slates, etc.), database servers, network storage devices and other network devices, smart phones and other cell phones, consumer electronics, wearable devices, digital music player devices, handheld gaming devices, PDAs, wireless phones, Internet appliances, and various other consumer products that include appropriate communication capabilities. In addition, the functionality provided by the illustrated ADAUA system 140 may in some embodiments be distributed in various components, some of the described functionality of the ADAUA system 140 may not be provided, and/or other additional functionality may be provided.

It will also be appreciated that, while various items are illustrated as being stored in memory or on storage while being used, these items or portions of them may be transferred between memory and other storage devices, such as for purposes of execution, memory management, data integrity, etc. Alternatively, in other embodiments some or all of the software components and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., by the ADAUA system 140 executing on server computing systems 300) and/or data structures, such as by execution of software instructions of the one or more software programs and/or by storage of such software instructions and/or data structures, and such as to perform algorithms as described in the flow charts and other disclosure herein. Furthermore, in some embodiments, some or all of the systems and/or components may be implemented or provided in other manners, such as by consisting of one or more means that are implemented partially or fully in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, components and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

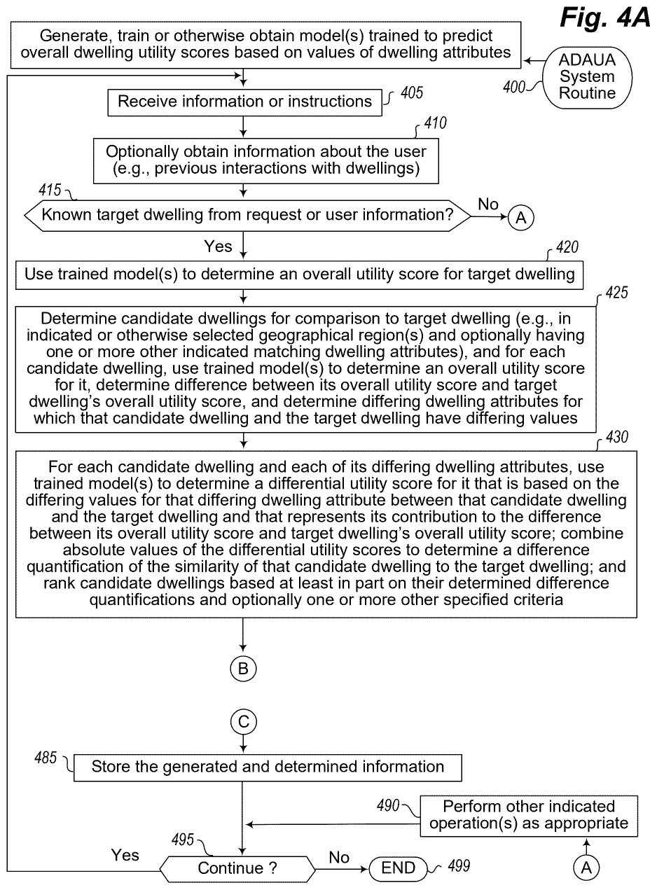

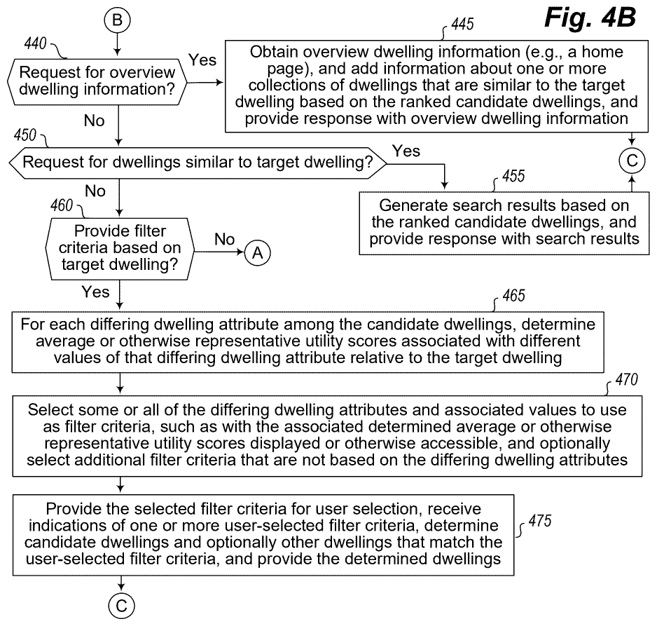

FIGS. 4A-4B are a flow diagram of an example embodiment of an ADAUA system routine 400. The routine may be provided by, for example, execution of the ADAUA system 140 of FIGS. 1A-1B, and/or the ADAUA system 140 of FIG. 3, and/or corresponding functionality discussed with respect to FIGS. 2A-2D and elsewhere herein, such as to perform automated operations that provide a computer-implemented method related to automatically quantifying and using overall differences between dwellings based on assessed contributions of differing dwelling attributes between the dwellings to differences in overall dwelling utility of the dwellings. In the illustrated embodiment, the routine interacts with a single user at a time to provide dwelling response information to search queries and other requests from that user, and determines similar candidate dwellings with respect to a single target dwelling at a time, but it will be appreciated that the routine may interact in a similar manner with multiple users (e.g., sequentially or concurrently) and/or may determine similarity of candidate dwellings to multiple target dwellings for a user (whether sequentially or concurrently, including to determine similarity of a candidate dwelling to multiple concurrent target dwellings, such as by using cumulative or average quantified differences of the candidate dwelling to the multiple target dwellings), and that the routine may in other embodiments perform similar types of activities for other types of information.

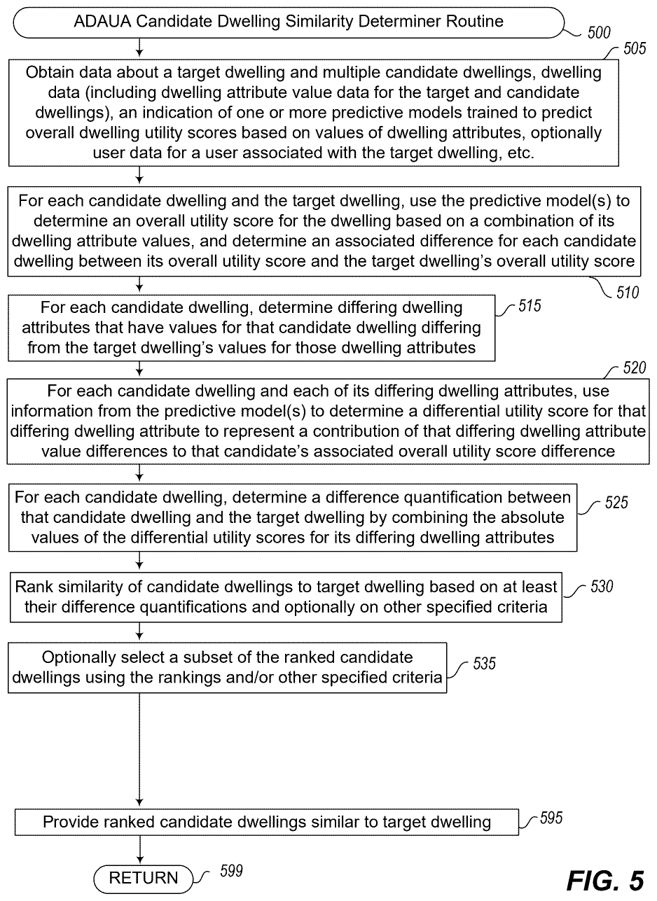

In the illustrated embodiment, the routine 400 begins at 403, where it generates, trains or otherwise obtains one or more predictive models for use in predicting overall utility scores for dwellings based on combinations of the dwellings'attributes. The routine continues to block 405, where it receives information or instructions, such as a request from the user, and in block 410 optionally retrieves or otherwise obtains information about the user (e.g., previous interactions with dwellings, including any target dwellings associated with the user). In block 415, the routine determines if a request is received in block 405 in which a target dwelling for a user is indicated or otherwise known, and if so proceeds to perform blocks 420-485, and otherwise continues to block 490. In block 420, the routine uses one or more trained predictive models to determine an overall utility score for the target dwelling. In block 425, the routine determines candidate dwellings for comparison to the target dwelling (e.g., in one or more indicated or otherwise selected geographical regions, and optionally having one or more other indicated matching dwelling attributes), and for each such candidate dwelling, uses the one or more trained predictive models to determine an overall utility score for it, determines a difference between the candidate dwelling's overall utility score and that of the target dwelling, and determines differing dwelling attributes for that candidate dwelling that have differing values between that candidate dwelling and the target dwelling. In block 430, the routine then, for each candidate dwelling and each of its differing dwelling attributes, uses the one or more trained predictive models to determine a differential utility score for that differing dwelling attribute and candidate dwelling that represents the contribution of that differing dwelling attribute to the difference between the overall utility score of that candidate dwelling and the overall utility score for the target dwelling, and then combines the absolute values of the differential utility scores for that candidate dwelling's various differing dwelling attributes to generate a difference quantification for that candidate dwelling of its similarity to the target dwelling after the difference qualifications have been generated for all of the candidate dwellings, the routine further ranks the candidate dwellings based at least in part on those determined difference quantifications and optionally on one or more other specified criteria. In some embodiments and situations, the operations of block 430 are performed by executing an ADAUA Candidate Dwelling Similarity Determiner component, with one example of a corresponding component routine being illustrated with respect to FIG. 5.

After block 430, the routine continues to block 440 to determine whether the instructions or other information received in block 405 are a request for overview dwelling information, and if so proceeds to block 445 where it obtains overview dwelling information and adds information to that overview dwelling information about one or more collections or other groups of dwellings that are similar to the target dwelling using the ranked candidate dwelling information from block 430, and provides a response with that overview dwelling information. Otherwise, the routine continues to block 450 to determine whether the instructions or other information received in block 405 are a search request or other request for dwellings similar to a target dwelling, and if so proceeds to block 455 to generate search results that are based on the ranked candidate dwellings from block 430, and provides a response with the search results. Otherwise, the routine continues to block 460 to determine whether the instructions or other information received in block 405 are an indication to provide filter criteria for other dwellings similar to the target dwelling, and if not proceeds to block 490. Otherwise, the routine continues to block 465 to, for each differing dwelling attribute among the candidate dwellings, determine average or otherwise representative utility scores associated with different values of that differing dwelling attribute relative to the target dwelling. In block 470, the routine then selects some or all of the differing dwelling attributes and associated values to use as filter criteria, such as along with the associated determined average or otherwise representative utility scores for those different dwelling attributes and values being displayed or otherwise accessible, and optionally selects additional filter criteria to include that are not based on the differing dwelling attributes. In block 475, the routine then provides the selected filter criteria for display to the user, receives an indication of one or more of the filter criteria that are selected by the user, determines candidate dwellings and optionally other dwellings that match the user-selected filter criteria, and provides information about the determined dwellings. After blocks 445, 455 or 475, the routine continues to block 485, where it stores the information generated in determined in blocks 425-475.

In block 490, the routine proceeds to perform one or more other indicated operations as appropriate, with non-exclusive examples of such other operations including retrieving and providing previously determined or generated information (e.g., previous user queries, previously determined responses to user queries, previously determined information used in determining similarity of candidate dwellings to target dwellings, etc.), receiving and storing information for later use (e.g., information about dwelling data 321, user data 328, ADAUA system data 327, etc.), responding to other types of search queries (e.g., using user-specified filters), receiving and using feedback from a user in response to provided query responses, providing information about how one or more previous query responses were determined, performing housekeeping operations, etc.

After blocks 485 or 490, the routine continues to block 495 to determine whether to continue, such as until an explicit indication to terminate is received (or alternatively only if an explicit indication to continue is received). If it is determined to continue, the routine returns to block 405 to await further information or instructions from the same user, and if not continues to block 499 and ends.

FIG. 5 is a flow diagram of an example embodiment of an ADAUA Candidate Dwelling Similarity Determiner routine 500. The routine may be provided by, for example, execution of the ADAUA Candidate Dwelling Similarity Determiner component 145 of FIGS. 1A-1B and/or a corresponding component (not shown) of the ADAUA system 140 of FIG. 3 and/or with respect to corresponding functionality discussed with respect to FIGS. 2A-2D and elsewhere herein, such as to perform activities that provide a computer-implemented method to use one or more predictive models to generate a ranking of candidate dwellings based on similarity to a target dwelling using determined quantified difference measures for the candidate dwellings based on differing dwelling attributes between the target dwelling and the candidate dwellings. In addition, in at least some situations, the routine 500 may be performed based on execution of block 430 of FIGS. 4A-4B, with resulting information provided and execution control returning to that location when the routine 500 ends-in other embodiments, the routine may be invoked in other manners. In this example, the routine 500 is performed using particular ways to generate particular types of ranked similar candidate dwellings for a target dwelling, but in other embodiments may use other techniques to generate the same or other types of information, whether in addition to or instead of the illustrated types of techniques.

The illustrated embodiment of the routine 500 begins at block 505, where data is obtained about a target dwelling and multiple candidate dwellings associated with it (including dwelling data that includes dwelling attribute value data for the target and candidate dwellings), indications of one or more trained predictive models, and optionally user data for a user associated with the target dwelling. In block 510, the routine then determines, for each candidate dwelling and the target dwelling and by using one or more trained predictive models, an overall utility score for the dwelling based on a combination of its dwelling attributes, and further determines an associated difference for each candidate dwelling between its overall utility score and the overall utility score of the target dwelling. In block 515, the routine then, for each candidate dwelling, determines differing dwelling attributes relative to the target dwelling that have values for that candidate dwelling that differ from the target dwelling's values for those dwelling attributes. In block 520, the routine then, for each candidate dwelling and each of its differing dwelling attributes, uses information from the one or more trained predictive models to determine a differential utility score for that differing dwelling attribute to represent a contribution to that candidate dwelling's associated overall utility score difference with the target dwelling from that differing dwelling attribute based on the differences in its value for the candidate dwelling relative to the target dwelling. In block 525, the routine then, for each candidate dwelling, determines an overall difference quantification between that candidate dwelling and the target dwelling by combining the absolute values of the differential utility scores for the differing dwelling attributes of that candidate dwelling, and in block 530 ranks the similarity of the candidate dwellings to the target dwelling based on their difference qualifications and optionally on one or more other specified criteria. After block 530, the routine optionally performs block 535 to select a subset of the ranked candidate dwellings using the rankings and/or one or more other specified criteria, and then proceeds in block 595 to provide resulting ranked candidate dwellings that are similar to the target dwelling. The routine then continues to block 599 and returns, such as to return to the flow of FIGS. 4A-4B at block 430 if invoked from there.

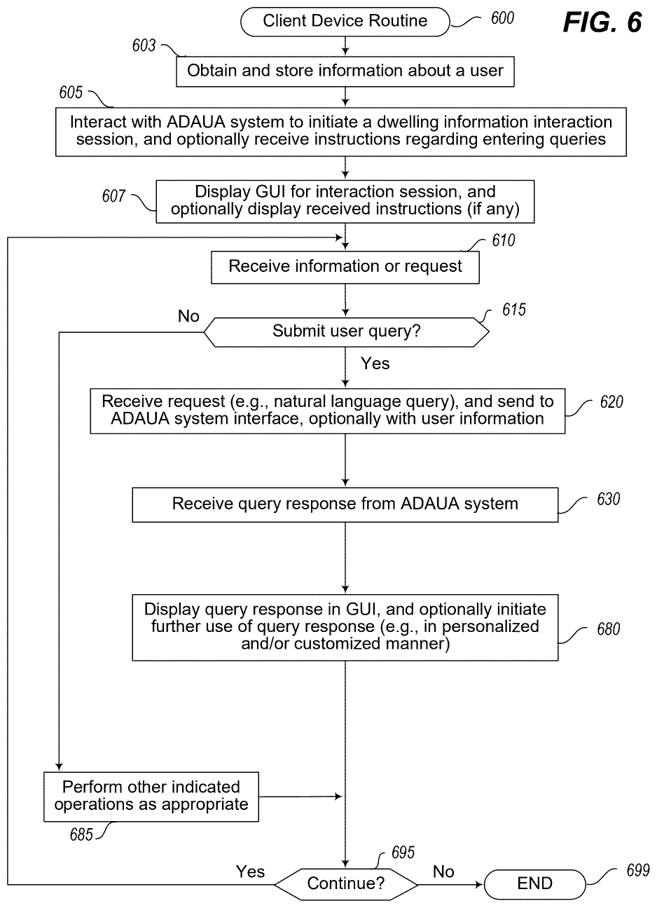

FIG. 6 is a flow diagram of an example embodiment of a client device routine 600. The routine may be provided by, for example, operations of a client computing device 360 of FIGS. 1A-1B and/or a client computing device 360 of FIG. 3 and/or with respect to corresponding functionality discussed with respect to FIGS. 2A-2D and elsewhere herein, such as to perform activities that provide a computer-implemented method to interact with users or other entities who submit queries (or other requests or information) to the ADAUA system, to receive responsive answers (or other information) from the ADAUA system, and to optionally use the received information in one or more manners (e.g., to automatically initiate follow-up activities in accordance with a received responsive answer).

The illustrated embodiment of the routine 600 begins at block 603, where information is optionally obtained and stored about the user, such as for later use in personalizing or otherwise customizing further actions to that user. The routine then continues to block 605 to interact with the ADAUA system to initiate an interaction session (e.g., in response to a corresponding instruction from the user), as well as to optionally receive a greeting and/or introductory instructions regarding using a GUI of the ADAUA system. In block 607, the routine then displays a GUI for the interaction session, and optionally displays the received greeting and/or introductory instructions, if any. The routine then continues to perform blocks 610-685 as part of participating in the interaction session.

In particular, the routine continues to block 610 after block 607, where it waits until information or a request is received from the user. In block 615, the routine determines if the information or request received in block 610 is a request to submit, such as a search query in a natural language format (e.g., freeform text), and if not continues to block 685. Otherwise, the routine continues to block 620, where it sends the received query to the ADAUA system interface, optionally along with additional information about the user from block 603, to obtain a corresponding responsive answer-in other embodiments, the routine may further modify the received user query to personalize and/or customize the information to be provided to the ADAUA system (e.g., to add information specific to the user, such as location, demographic information, preference information, previously indicated target dwelling(s), etc.). In block 630, the routine then receives a responsive answer to the query from the ADAUA system. In block 680, the routine then displays the received query response in the GUI, and optionally initiates further use of the query response in one or more manners (e.g., in a manner that is personalized and/or customized for the user)-in some embodiments, the further initiated activities may include invoking of other functionality of the ADAUA system, such as to initiate an inspection process for a selected dwelling indicated in dwelling information search results, to initiate a mortgage application process for a selected dwelling indicated in dwelling information search results, to initiate matching the user with a real estate professional as part of a housing search based on corresponding response information received from the ADAUA system, etc.

In block 685, the routine instead performs one or more indicated operations as appropriate other than receiving and submitting a query, with non-exclusive examples including sending information to the ADAUA system of other types, receiving and storing user data for later use in personalization and/or customization activities, receiving and responding to requests for information about previous user queries and/or corresponding responsive answers for a current user and/or client device, receiving and responding to indications of one or more housekeeping activities to perform, etc. After blocks 680 or 685, the routine continues to block 695 to determine whether to continue, such as until an explicit indication to terminate is received (or alternatively only if an explicit indication to continue is received). If it is determined to continue, the routine returns to block 610, and if not continues to block 699 and ends.

It will be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, synchronously or asynchronously, etc.) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the claims that are specified and the elements recited therein. In addition, while certain aspects of the invention may be presented at times in certain claim forms, the inventors contemplate the various aspects of the invention in any available claim form. For example, while only some aspects of the invention may be recited at a particular time as being embodied in a computer-readable medium, other aspects may likewise be so embodied.

1. A computer-implemented method comprising:
receiving, by one or more computing systems, a search query indicating a target house having multiple dwelling attributes each with one or more indicated values;
generating, by the one or more computing systems, search results in response to the search query by:
determining, by the one or more computing systems, multiple candidate houses that are located within a defined distance of a geographical location of the target house, each of the multiple candidate houses having one or more associated values for each of the multiple dwelling attributes;
determining, by the one or more computing systems and using a predictive feed forward neural network model trained to provide overall utility scores for houses based on values for those houses of the multiple dwelling attributes, an overall target utility score for the target house, and respective overall utility scores for the multiple candidate houses;
determining, by the one or more computing systems, respective quantifications of differences between the multiple candidate houses and the target house based at least in part on the multiple dwelling attributes, including, for each of the multiple candidate houses:
determining, by the one or more computing systems, two or more differing dwelling attributes of the multiple dwelling attributes for that candidate house relative to the target house, wherein each of the two or more differing dwelling attributes has one or more indicated values for the target house that differ from the one or more associated values for that differing dwelling attribute for the candidate house;
determining, by the one or more computing systems and for each of the two or more differing dwelling attributes, a differential utility score for that dwelling attribute of that candidate house using the trained predictive feed forward neural network model, wherein the differential utility score is associated with a difference between the one or more indicated values of that dwelling attribute for the target house and the one or more associated values of that dwelling attribute for the candidate house, and represents a percentage contribution of that dwelling attribute to an overall difference between the determined respective overall utility score for that candidate house and the determined overall target utility score for the target house, and wherein the determining of the differential utility score for each of the two or more differing dwelling attributes of each of the multiple candidate dwellings using the trained predictive feed forward neural network model includes at least one of:
identifying and using weighting data internal to the trained predictive feed forward neural network model associated with that differing dwelling attribute to determine the differential utility score for that differing dwelling attribute; or
determining and using differences between activation values of nodes of the trained predictive feed forward neural network model for the one or more associated values of that differing dwelling attribute for that candidate dwelling and for the one or more indicated values of that differing dwelling attribute for the target dwelling; or
perturbating input to the trained predictive feed forward neural network model for a plurality of values of that differing dwelling attribute and determining resulting differences in the overall utility score that is output by the trained predictive neural network model as part of determining the contribution of that differing dwelling attribute to the overall difference between the overall utility score for that candidate dwelling and the overall utility score for the target dwelling; or
using conditional expectations for multiple values of that differing dwelling attribute to determine the contribution of that differing dwelling attribute to the overall difference between the overall utility score for that candidate dwelling and the overall utility score for the target dwelling; and
combining, by the one or more computing systems, the differential utility scores for the two or more differing dwelling attributes for that candidate house to generate the determined quantification of difference between that candidate house and the target house;
ranking, by the one or more computing systems, the multiple candidate houses based on the determined quantifications of differences; and
selecting, by the one or more computing systems, some of the ranked candidate houses as the search results based on the some ranked candidate houses having respective determined quantifications of differences below a defined threshold; and
presenting, by the one or more computing systems and in a displayed graphical user interface, information about the some ranked candidate houses.

2. The computer-implemented method of claim 1 wherein the determining for each of the multiple candidate houses of the differential utility score for each of the determined two or more differing dwelling attributes includes extracting the weighting data internal to the trained predictive feed forward neural network model associated with that differing dwelling attribute, and using the extracted weighting data to determine the differential utility score for that differing dwelling attribute.

3. The computer-implemented method of claim 1 wherein the defined distance of the geographical location of the target house includes one or more geographical regions, wherein the predictive feed forward neural network model is trained to predict the overall utility scores for houses in the one or more geographical regions, wherein the determined differential utility scores for the two or more differing dwelling attributes of the multiple candidate houses include negative utility scores and positive utility scores, and wherein the combining of the differential utility scores for each of the multiple candidate houses includes adding absolute values for the determined utility scores for the two or more differing dwelling attributes of that candidate house.

4. A computer-implemented method comprising:
determining, by one or more computing systems and for an indicated target dwelling having multiple dwelling attributes each with one or more indicated values, multiple candidate dwellings for comparison to the target dwelling, wherein the multiple candidate dwellings are located in one or more selected geographical areas associated with the target dwelling and each has one or more associated values for each of the multiple dwelling attributes;
determining, by the one or more computing systems, respective quantifications of differences between the multiple candidate dwellings and the target dwelling based at least in part on the multiple dwelling attributes, including, for each of the multiple candidate dwellings:
determining, by the one or more computing systems and for each of two or more dwelling attributes of the multiple dwelling attributes, that the one or more associated values of that dwelling attribute for that candidate dwelling differ from the one or more indicated values of that dwelling attribute for the target dwelling;
determining, by the one or more computing systems and for each of the two or more dwelling attributes, and using a predictive neural network model trained to provide overall utility scores for dwellings based on combinations of values of the multiple dwelling attributes for those dwellings, a differential utility score for that dwelling attribute of that candidate dwelling, wherein the differential utility score is associated with a difference between the one or more indicated values of that dwelling attribute for the target dwelling and the one or more associated values of that dwelling attribute for the candidate dwelling, and represents a contribution of that dwelling attribute to an overall difference between an overall utility score for that candidate dwelling and an overall utility score for the target dwelling, and wherein the determining of the differential utility score for each of the two or more dwelling attributes of each of the multiple candidate dwellings using the trained predictive neural network model includes at least one of:
identifying and using weighting data of the trained predictive neural network model associated with that dwelling attribute to determine the differential utility score for that dwelling attribute; or
determining and using differences between activation values of nodes of the trained predictive neural network model for the one or more associated values of that dwelling attribute for that candidate dwelling and for the one or more indicated values of that dwelling attribute for the target dwelling; or
perturbating input to the trained predictive neural network model for a plurality of values of that dwelling attribute and determining resulting differences in the overall utility score that is output by the trained predictive neural network model as part of determining the contribution of that dwelling attribute to the overall difference between the overall utility score for that candidate dwelling and the overall utility score for the target dwelling; or
using conditional expectations for multiple values of that dwelling attribute to determine the contribution of that dwelling attribute to the overall difference between the overall utility score for that candidate dwelling and the overall utility score for the target dwelling; and
combining, by the one or more computing systems, the differential utility scores for the two or more dwelling attributes for that candidate dwelling to generate the determined quantification of difference between that candidate dwelling and the target dwelling;
ranking, by the one or more computing systems, the multiple candidate dwellings based on the determined quantifications of differences; and
providing, by the one or more computing systems and as search results based on the target dwelling, at least some of the multiple candidate dwellings that are selected based on the ranking.

5. The computer-implemented method of claim 4 further comprising receiving, by the one or more computing systems and before the determining of the respective quantifications of differences between the multiple candidate dwellings and the target dwelling, a search query that indicates the target dwelling and one or more additional search criteria, and wherein at least one of the determining of the multiple candidate dwellings or the ranking of the multiple candidate dwellings is performed based at least in part on the one or more additional search criteria.

6. The computer-implemented method of claim 4 wherein the one or more geographical areas are within a geographical region in which the target dwelling is located, wherein the target dwelling has a dwelling type that is one of a house or a home or an apartment or a condominium, and wherein the determining of the multiple candidate dwellings includes selecting some or all dwellings in the one or more geographical areas that are of the dwelling type.

7. The computer-implemented method of claim 6 wherein the selecting of the some or all dwellings in the one or more geographical areas that are of the dwelling type further includes selecting a subset of some of the dwellings in the one or more geographical areas that are of the dwelling type, including, for one or more selected dwelling attributes of the multiple dwelling attributes, excluding dwellings in the one or more geographical areas that are of the dwelling type but that have associated values for the one or more selected dwelling attributes that differ from the indicated values for the one or more selected dwelling attributes of the target dwelling, and wherein the determined two or more dwelling attributes are different from the one or more selected dwelling attributes.

8. The computer-implemented method of claim 4 wherein the determining of the differential utility score for each of the two or more dwelling attributes of each of the multiple candidate dwellings using the trained predictive neural network model includes identifying and using the weighting data of the trained predictive neural network model associated with that dwelling attribute to determine the differential utility score for that dwelling attribute.

9. The computer-implemented method of claim 4 wherein the determining of the differential utility score for each of the two or more dwelling attributes of each of the multiple candidate dwellings using the trained predictive neural network model includes determining and using the differences between the activation values of the nodes of the trained predictive neural network model for the one or more associated values of that dwelling attribute for that candidate dwelling and for the one or more indicated values of that dwelling attribute for the target dwelling.

10. The computer-implemented method of claim 4 wherein the determining of the differential utility score for each of the two or more dwelling attributes of each of the multiple candidate dwellings using the trained predictive neural network model includes using at least one of perturbating the input to the trained predictive neural network model for the plurality of values of that dwelling attribute and determining the resulting differences in the overall utility score that is output by the trained predictive neural network model as part of determining the contribution of that dwelling attribute to the overall difference between the overall utility score for that candidate dwelling and the overall utility score for the target dwelling, or using shapley values to determine the contribution of that dwelling attribute to the overall difference between the overall utility score for that candidate dwelling and the overall utility score for the target dwelling, or using the conditional expectations for the multiple values of that dwelling attribute to determine the contribution of that dwelling attribute to the overall difference between the overall utility score for that candidate dwelling and the overall utility score for the target dwelling.

11. The computer-implemented method of claim 4 wherein the predictive neural network model is trained to provide the overall utility scores for dwellings in the one or more geographical areas, and wherein the method further comprises receiving a search query from a client device that indicates the target dwelling, and wherein the providing of the information about the at least some candidate dwellings as the search results includes transmitting, by the one or more computing devices, the search results with the information about the at least some candidate dwellings over one or more computer networks to the client device for display on the client device.

12. A system comprising:
one or more hardware processors of one or more computing devices; and
one or more memories with stored instructions that, when executed by at least one of the one or more hardware processors, cause at least one computing device of the one or more computing devices to perform automated operations including at least:
determining, for an indicated target dwelling having multiple dwelling attributes each with one or more indicated values, multiple candidate dwellings for comparison to the target dwelling, wherein the multiple candidate dwellings each has one or more associated values for each of the multiple dwelling attributes;
determining respective quantifications of differences between the multiple candidate dwellings and the target dwelling, including, for each of the multiple candidate dwellings:
determining, for each of one or more dwelling attributes of the multiple dwelling attributes, that the one or more associated values of that dwelling attribute for that candidate dwelling differ from the one or more indicated values of that dwelling attribute for the target dwelling;
determining, for each of the one or more dwelling attributes, and using a predictive neural network model trained to provide overall utility scores for dwellings based on combinations of values of the multiple dwelling attributes for those dwellings, a differential utility score for that dwelling attribute of that candidate dwelling that is associated with a difference between the one or more associated values of that dwelling attribute for the candidate dwelling and the one or more indicated values of that dwelling attribute for the target dwelling. and represents a contribution of that dwelling attribute to an overall difference between an overall utility score for that candidate dwelling and an overall utility score for the target dwelling, and wherein the determining of the differential utility score for each of the one or more dwelling attributes of each of the multiple candidate dwellings using the trained predictive neural network model includes at least one of:
identifying and using weighting data of the trained predictive neural network model associated with that dwelling attribute to determine the differential utility score for that dwelling attribute; or
determining and using differences between activation values of nodes of the trained predictive neural network model for the one or more associated values of that dwelling attribute for that candidate dwelling and for the one or more indicated values of that dwelling attribute for the target dwelling; or
perturbating input to the trained predictive neural network model for a plurality of values of that dwelling attribute and determining resulting differences in the overall utility score that is output by the trained predictive neural network model as part of determining the contribution of that dwelling attribute to the overall difference between the overall utility score for that candidate dwelling and the overall utility score for the target dwelling; or
using conditional expectations for multiple values of that dwelling attribute to determine the contribution of that dwelling attribute to the overall difference between the overall utility score for that candidate dwelling and the overall utility score for the target dwelling; and
generating the determined quantification of difference between that candidate dwelling and the target dwelling based on the differential utility scores for the one or more dwelling attributes for that candidate dwelling; and
providing indications of at least some of the multiple candidate dwellings that are selected based on the respective determined quantifications of differences for the at least some candidate dwellings.

13. The system of claim 12 wherein the stored instructions include software instructions that, when executed by the one or more hardware processors, cause the one or more computing devices to perform further automated operations including receiving a search query that indicates the target dwelling, and wherein the providing of the indications of the at least some candidate dwellings includes presenting, in a displayed graphical user interface, search results for the search query that include information about the at least some candidate dwellings.

14. The system of claim 12 wherein the one or more dwelling attributes for each of the at least some candidate dwellings include two or more dwelling attributes, and wherein the automated operations further include selecting each of the at least some candidate dwellings based on a combination of the determined differential utility scores for the two or more dwelling attributes for that candidate dwelling.

15. The system of claim 12 wherein the automated operations further include at least one of selecting dwellings that include the at least some candidate dwellings and performing the providing of the indications about the at least some candidate dwellings by presenting the selected dwellings as a group of related dwellings, or excluding a subset of the multiple candidate dwellings that are not the at least some candidate dwellings and performing the providing of the information about the at least some candidate dwellings by presenting only the at least some candidate dwellings as available options for at least one of filtering or selection.

16. The system of claim 12 wherein the automated operations further include determining, for each of at least one of the multiple dwelling attributes, an aggregate utility score for at least one value of that dwelling attribute by combining determined utility scores for that dwelling attribute from two or more of the multiple candidate dwellings, and providing one or more indications of the determined aggregate utility score for the at least one value of each of the at least one dwelling attributes.

17. The system of claim 12 wherein the target dwelling has a dwelling type that is one of a house or a home or an apartment or a condominium, and wherein the determining of the multiple candidate dwellings includes selecting candidate dwellings that are in a geographical region associated with the target dwelling and that each are of the dwelling type.

18. A non-transitory computer-readable medium having stored contents that cause one or more computing devices to perform automated operations, the automated operations including at least:
determining, by the one or more computing devices and for an indicated group of multiple dwelling attributes each with one or more indicated values, multiple candidate dwellings for comparison that each has one or more associated values for each of the multiple dwelling attributes;
determining, by the one or more computing devices, respective quantifications of differences between the multiple candidate dwellings and the indicated group of multiple dwelling attributes, including, for each of the multiple candidate dwellings:
determining, by the one or more computing devices and for each of one or more dwelling attributes of the multiple dwelling attributes, that the one or more associated values of that dwelling attribute for that candidate dwelling differ from the one or more indicated values of that dwelling attribute for the indicated group;
determining, by the one or more computing devices and for each of the one or more dwelling attributes, and using a predictive neural network model trained to provide overall utility scores based on combinations of values of the multiple dwelling attributes, a differential utility score for that dwelling attribute of that candidate dwelling that is associated with a difference between the one or more associated values of that dwelling attribute for the candidate dwelling and the one or more indicated values of that dwelling attribute for the indicated group, and wherein the determining of the differential utility score for each of the one or more dwelling attributes of each of the multiple candidate dwellings using the trained predictive neural network model includes at least one of:
identifying and using weighting data of the trained predictive neural network model associated with that dwelling attribute to determine the differential utility score for that dwelling attribute; or
determining and using differences between activation values of nodes of the trained predictive neural network model for the one or more associated values of that dwelling attribute for that candidate dwelling and for the one or more indicated values of that dwelling attribute for the indicated group; or
perturbating input to the trained predictive neural network model for a plurality of values of that dwelling attribute and determining resulting differences in overall utility scores that are output by the trained predictive neural network model as part of determining a contribution of that dwelling attribute to an overall difference between an overall utility score for that candidate dwelling and an overall utility score for the indicated group; or
using conditional expectations for multiple values of that dwelling attribute to determine the contribution of that dwelling attribute to the overall difference between the overall utility score for that candidate dwelling and the overall utility score for the indicated group; and
generating, by the one or more computing devices, the determined quantification of difference between that candidate dwelling and the indicated group of multiple dwelling attributes based on the differential utility scores for the one or more dwelling attributes for that candidate dwelling; and
providing, by the one or more computing devices, indications of at least some of the multiple candidate dwellings that are selected based on the respective determined quantifications of differences for the at least some candidate dwellings.

19. The non-transitory computer-readable medium of claim 18 wherein the stored contents include software instructions that, when executed by the one or more computing devices, cause the one or more computing devices to perform further automated operations including receiving a search query that indicates the group of multiple dwelling attributes, and wherein the providing of the indications of the at least some candidate dwellings includes presenting, in a displayed graphical user interface, search results for the search query that include information about the at least some candidate dwellings.

20. The non-transitory computer-readable medium of claim 19 wherein the group of multiple dwelling attributes indicated in the search query are a target dwelling.

21. The non-transitory computer-readable medium of claim 18 wherein the one or more dwelling attributes for each of the at least some candidate dwellings include two or more dwelling attributes, wherein the determined differential utility score for each dwelling attribute of a candidate dwelling represents a contribution of that dwelling attribute to the overall difference between the overall utility score for that candidate dwelling and the overall utility score for the indicated group, and wherein the automated operations further include selecting each of the at least some candidate dwellings based on a combination of the determined differential utility scores for the two or more dwelling attributes for that candidate dwelling.

22. The non-transitory computer-readable medium of claim 18 wherein the automated operations include generating a linear model to associate values of the multiple dwelling attributes with overall utility scores of dwellings having those values of the multiple dwelling attributes, and wherein the determining of the differential utility score for each dwelling attribute of a candidate dwelling includes using normalized coefficients of the generated linear model.

23. The non-transitory computer-readable medium of claim 18 wherein the indicated group of multiple dwelling attributes further has an associated geographical region and an associated dwelling type that is one of a house or a home or an apartment or a condominium, and wherein the determining of the multiple candidate dwellings includes selecting candidate dwellings that are in the associated geographical region and that each are of the dwelling type.
